(19) United States
(12) Patent Application Publication
(10) Pub. No.: US 2008/0128034 A1
(43) Pub. Date: Jun. 5, 2008

(54) Handle Lever Locking Mechanism for Dry Disconnect Coupler

(75) Inventor: Richard L. Fahl, Fairfield, OH (US)

Correspondence Address: WOOD, HERRON & EVANS, LLP, 2700 CAREW TOWER, 441 VINE STREET, CINCINNATI, OH, 45202, US

(73) Assignee: DIXON VALVE AND COUPLING COMPANY, Chestertown, MD (US)

(21) Appl. No.: 11/565,691

(22) Filed: Dec. 1, 2006

(51) Int. Cl. F16L 37/28

(52) U.S. Cl. 137/614.06

(57) ABSTRACT

A coupler assembly wherein the coupler of the assembly has a locking mechanism mounted thereon for preventing a rotatable handle lever of the coupler from being rotated from a first locked position in which a projection of the handle lever is engaged with a stop surface of the coupler body to a second locked position in which the projection of the handle lever is engaged with a second stop surface of the coupler body.

### TECHNICAL FIELD

The present invention relates to fluid coupling devices and, more particularly, to a type of coupling known as a dry disconnect fluid coupling.

### BACKGROUND

In the chemical processing industries, and for anyone handling hazardous liquids or other difficult to clean-up costly substances where the product is transferred using temporary hose connections, it has become commonplace to utilize a type of connection or fitting known as a dry disconnect coupler. These devices make it possible to connect and disconnect liquid conveying conduits such that when the conduit connection is disconnected, the product being conveyed is not released or spilled to the environment.

There are various styles of these disconnect fittings and their operations and methods of sealing are quite different. This invention pertains to a specific style of dry disconnect coupler known as the cam and groove style coupler due to the fact that the coupler (cam end) is made to attach to an adapter (groove end) wherein the adapter attaching groove largely conforms to United States military standard MIL-C-27487. This fitting is also known in the industry as a Kamvalok style coupler where “Kamvalok” is a trademark of Dover Corporation.

The design of this coupler is such that when the coupler is not connected to a mating adapter, it is possible to rotate the operating handle lever from a closed position to an open position by simply pulling on the handle lever as is often done when dragging the coupler with hose attached from one location to another. It is also possible to cause the handle lever motion by inadvertently bumping the lever. Although no liquid is released when this happens, it is desirable in some installations to eliminate this occurrence.

There is one prior art product on the market for preventing this unintended handle lever motion, but it requires that a different handle lever be installed to the coupler as well as other parts. In addition, in order to field upgrade the coupler, the existing lever and shaft sealing gland known as the stuffing box must be replaced. This replacement of existing coupler components is one factor that makes the prior art product less desirable. Another factor that makes this existing prior art product less desirable is that field upgrades require the breaking or opening of liquid sealing connections on the coupler (i.e., replacing the stuffing box) which then requires that the coupler be pressure tested before returning to service. Another consequence of installing this prior art product is that the aforementioned new required handle lever cannot use the existing coupler stop lugs to limit the angular rotation of the handle lever. As a result, a locking plate must be installed between the stuffing box and the coupler main body to provide this angular rotation limit. Since the plate is serving the function of limiting the lever angular travel, torque from any force applied to the lever is now transmitted to the stuffing box, which can cause the stuffing box to loosen.

Another prior art product that is sold to prevent the unintended lever motion is a sheet metal spring clip. In order to field upgrade to this item, holes must be drilled and tapped into the coupler body if they do not already exist. This makes field upgrading difficult. Also, the sheet metal latch is not a strong robust design and is subject to damage in the field that renders it ineffective. Another limitation of this prior art spring clip is that it only prevents unintended motion from the closed position to the open position and not from the open position to the closed position.

### SUMMARY OF THE INVENTION

The invention of this application provides a locking device to prevent the unintended motion of the coupler operating handle lever that does not require the replacement of costly coupler components when applied or retrofitted to an existing coupler. It utilizes the existing coupler stop lugs to limit the handle lever angular travel so an additional handle lever travel stopping device is not required. This invention also has the advantage that it can be field retrofitted to an existing coupler without breaking any coupler liquid seals.

The coupler to which this invention is applied includes a tubular coupler body, a poppet valve contained within the body, and a rotatable handle lever for controlling opening and closing of the poppet valve. The poppet is coupled to the handle lever such that rotation of the handle results in opening and closing movement of the poppet valve. The coupler body feature includes a pair of stop surfaces thereon engageable with a projection of the handle lever for controlling the limits of rotation of the handle lever. In accordance with the practice of this invention, a lock mechanism, including a latch, is mounted upon the handle and is biased into a locking position of the latch such that when in the locking position, the latch prevents movement of the handle lever relative to the coupler body, but when moved against the bias to an unlatched position, it enables the handle lever to be moved from a position in which the handle lever projection is in engagement with the first one of the pair of stop surfaces of the coupler body to a second position in which the projection of the handle lever is in engagement with the second stop surface of the coupler body. Between stop surfaces, the latch rides upon a ledge surface of the coupler body which prevents the latch from moving into a locked position when moved between the two stop surfaces.

In a preferred embodiment of the invention, there is a lock mounted upon the latch of the lock mechanism for preventing the latch from being unlocked until the lock is first moved to an unlocked position on the latch.

A more complete understanding of the invention of this application will be derived from the following description of the drawings.

### BRIEF DESCRIPTION OF THE DRAWINGS

FIG. 1 is a perspective view of a coupler device incorporating the invention of this application;

FIG. 2 is a cross-sectional view of the coupler device of FIG. 1 taken on line 2-2 of FIG. 1 illustrating the poppet valve and the handle lever of the coupler device in a closed position;

FIG. 3 is a cross-sectional view similar to FIG. 2, but illustrating the poppet valve and handle lever of the coupler device in an open position;

FIG. 4 is an exploded cross-sectional view of a coupler assembly including the coupler device of FIG. 1 and an adapter to be connected to the coupler device;

FIG. 5 is a cross-sectional view of the assembled coupler assembly of FIG. 4;

FIG. 6 is an exploded cross-sectional view of an end portion of the coupler device and the adapter of FIG. 4, but with the coupler device rotated 90° from the position of FIG. 4 to illustrate the locking handle mechanism for securing the adapter to the coupler device;

FIG. 7 is a cross-sectional view similar to FIG. 6, but with the coupler device and adapter assembled and locked together;

FIG. 8 is a cross-sectional view of the combined coupler assembly, including the coupler and adapter with the valves of the assembly illustrated in the open position, facilitating the flow of fluid;

FIG. 9 is a side elevational view of the handle lever and the handle lever locking mechanism of the coupler of FIG. 1;

FIG. 9A is a top plan view of the handle lever and handle lever locking mechanism of FIG. 9;

FIG. 10A is a side elevational view partially broken away of the locking mechanism of FIG. 9 illustrating a force F1 applied to a first locking device of the locking mechanism;

FIG. 10B is a cross sectional view of the locking mechanism of FIG. 10A;

FIG. 11A is a side elevational view, partially broken away, of the locking mechanism of FIG. 9 with the first locking device depressed and a second force F2 applied to a latch of the locking mechanism;

FIG. 11B is a cross-sectional view of the locking mechanism of FIG. 11A;

FIG. 12A is a side elevational view of the locking mechanism of FIG. 9 with the locking device and the latch depressed and in an unlocked position of the locking mechanism; and

FIG. 12B is a cross-sectional view of the locking mechanism of FIG. 12A.

### DETAILED DESCRIPTION OF THE DRAWINGS

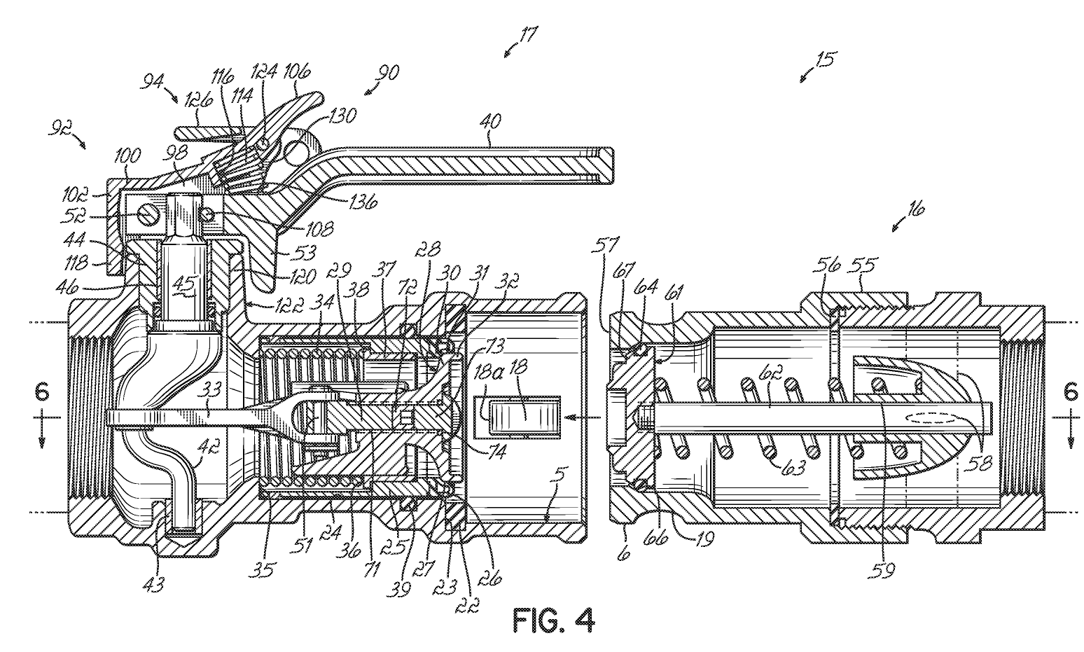

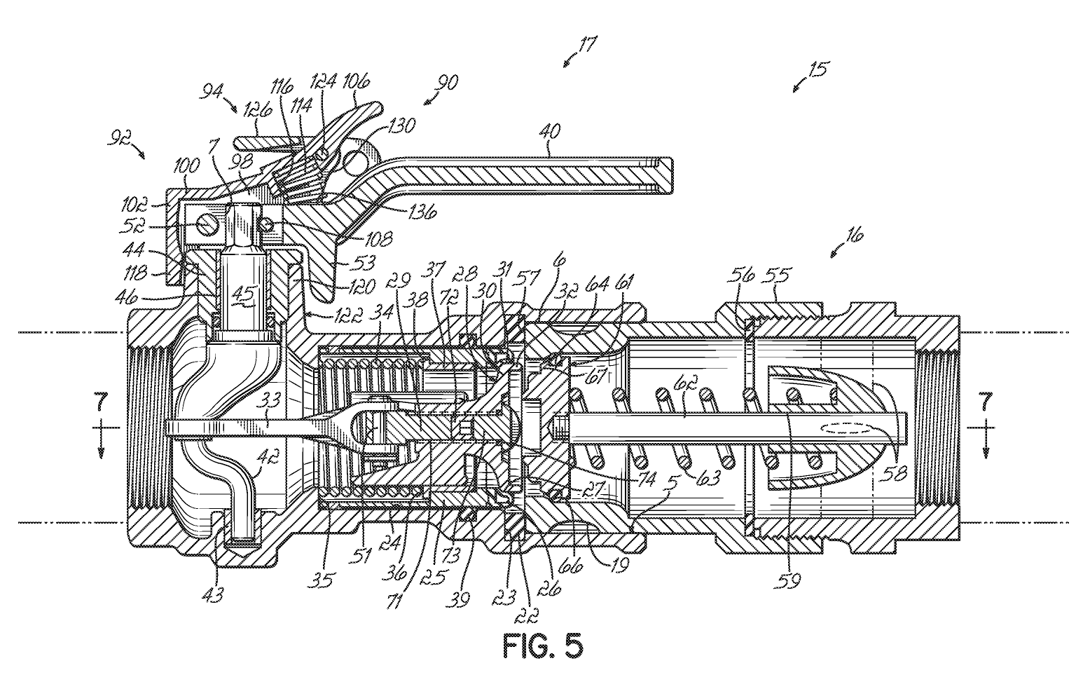

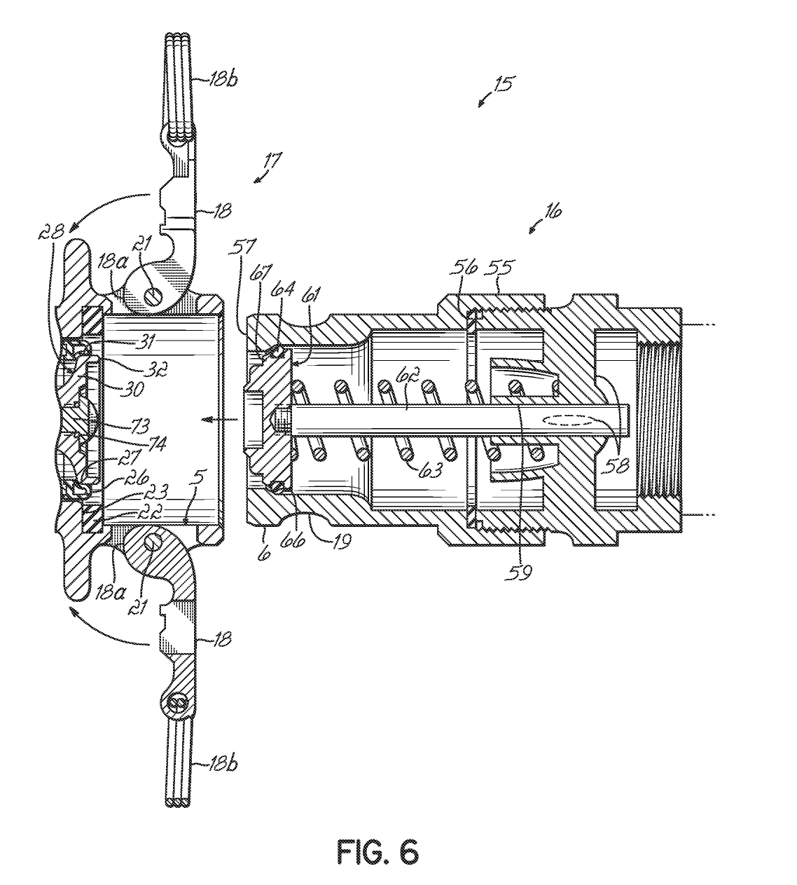

In the exemplary embodiment of this invention illustrated in the drawings, a dry disconnect coupler assembly 15 is illustrated. As seen in FIGS. 4 and 5, coupler assembly 15 comprises a pair of cooperating cylindrical members 16, 17 identified as a male adapter 16 and a female coupler 17 fastened together about a common axis by a cam and groove locking mechanism 18a, 19 provided on such members. See FIG. 6. The cooperating cylindrical members 16, 17 are readily fastened together irrespective of their angular positions about such common axis and each includes valve means for sealing fluid there within upon unfastening thereof to provide a dry break, i.e., the cooperating pair of cylindrical members 16, 17 are taken apart essentially without spilling or losing fluid in any way. An actuating handle lever 40 is provided on the female coupler 17 of the cooperating cylindrical members 16, 17 for opening and closing the valve means provided within the coupler assembly 15 to control fluid flow through such coupling.

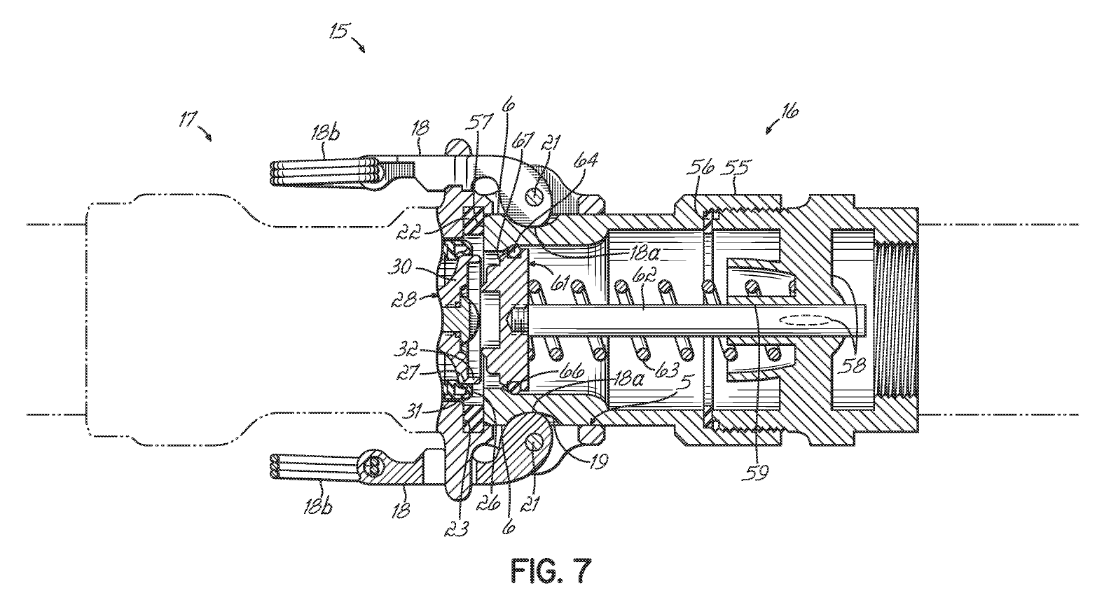

As best illustrated in FIGS. 6 and 7 of the drawings, the cam and groove locking mechanism 18a, 19 for fastening and unfastening the male adapter 16 and female coupler 17 comprises a pair of handles 18 fastened to coupler 17 on opposite sides thereof and a cooperating annular groove 19 in adapter 16. A pair of pivot pins 21 are suitably fixed to opposite sides of coupler 17. Each pivot pin 21 projects from coupler 17 and extends through a cooperating opening in an associated handle 18. Each handle 18 pivots about its associated pivot pin 21 and is held in position on such pin by any suitable means such as peening of the ends of the pins 21. Each handle 18 has an off center cam surface 18a adjacent its associated pin 21 such that with the handle 18 extending downwardly, as shown in FIG. 7, a portion of the cam surface 18a projects beyond the inner circumferential surface of coupler 17 and is received within groove 19 of adapter 16 to thereby fasten coupler 17 and adapter 16 together to form the assembled coupling 15. With handles 18 extending upwardly, as illustrated in FIG. 6, the previously projecting cam surface 18a is rotated away from adapter 16 and its groove 19 so that the male adapter 16 may be withdrawn from or inserted within female coupler 17.

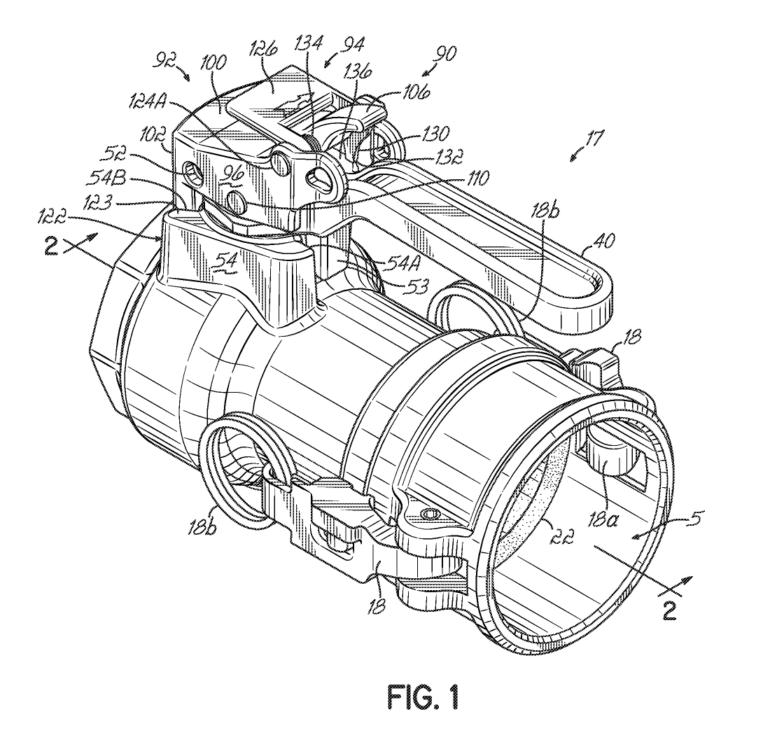

As shown in FIGS. 1, 6 and 7, coupling or coupler assembly 15 (the adapter 16 and coupler 17) is uncoupled or unfastened by lifting or pulling on rings or loops 18b secured to the ends of lock handles 18 to enable separation of such adapter 16 and coupler 17. See FIGS. 4 and 6. Alternatively, coupling 15 is coupled or fastened by inserting adapter 16 within the receiving bore 5 of coupler 17 so that a terminal end portion 6 of adapter 16 engages a gasket seal 22 supported on a shoulder 23 of coupler 17 and then lowering handles 18 against the body of coupler 17. See FIGS. 4, 5 and 6.

With adapter 16 fastened in position with its terminal end portion 6 engaging gasket 22 of coupler 17 a fluid seal is provided assuring that fluid carried within coupling 15 and its associated conduit system does not leak out. As will be apparent from the drawings, seal 22 within coupler 17 acts in effect as a double or backup seal while fluid is flowing through coupling 15.

As seen in FIG. 1, a handle lever 40 is provided for controlling fluid flow through coupling device 15. The handle lever 40 is carried by coupler 17. A detailed description of such handle lever 40 and the locking mechanism associated therewith is provided subsequently.

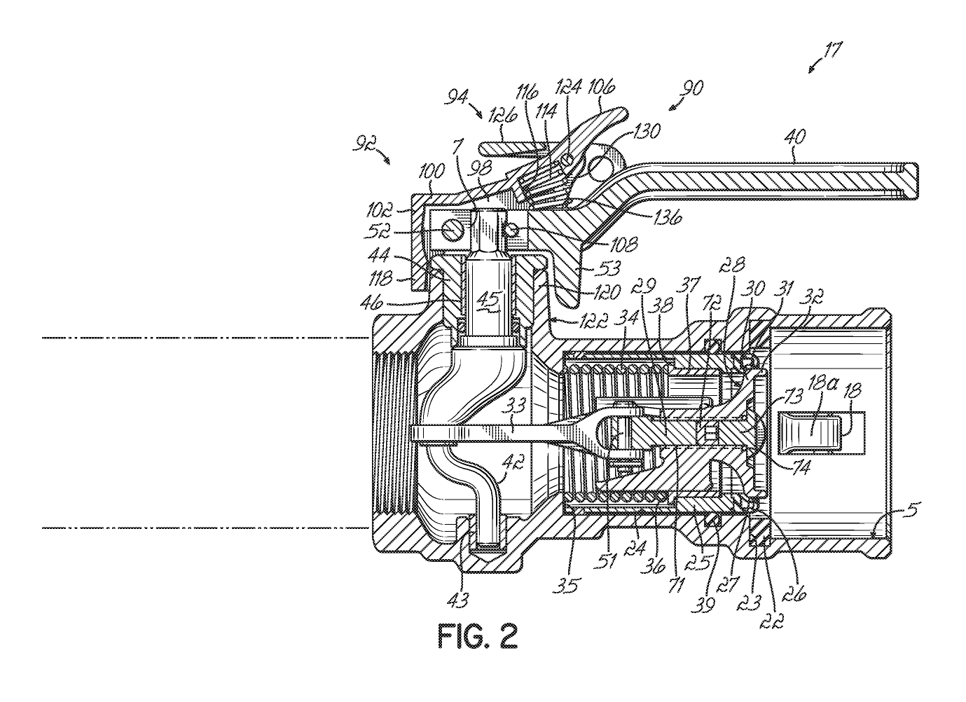

As best seen in FIGS. 2-4, coupler 17 has a circular cylindrical bore 24 and cooperating generally cylindrical sleeve 25 carried within bore 24 for telescoping movements. A lip seal 26 is provided on the outer terminal edge of sleeve 25 and includes a terminal sealing surface corresponding generally to the circumferential outline of sleeve 25 as well as a sealing portion 27 spaced inwardly from the outer periphery of sleeve 25.

Coupler 17 also has a poppet or poppet valve 28 provided for cooperation with sleeve 25. Poppet 28 has a stem 29 arranged generally coaxially within sleeve 25 and a generally circular disk-like head portion 30. Head 30 has a sealing surface 31 which cooperates with the sealing portion 27 of sleeve 25 to provide a fluid seal when the poppet 28 is in its closed position shown in FIGS. 4 and 5. Poppet 28 is supported within coupler 17 for axial movement generally along the axis of sleeve 25. The axial movement of poppet 28 is controlled by a connecting link 33 fastened at one end to stem 29 and at its opposite end to a crank 42. See FIGS. 4 and 5.

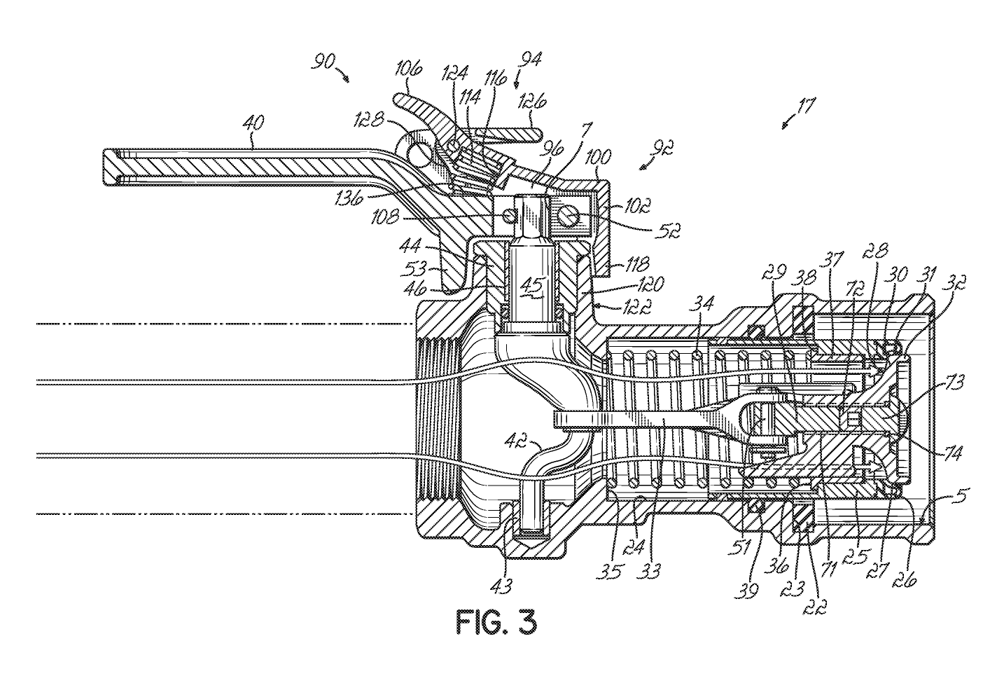

As seen in FIG. 3, bias in the form of a compression spring 34 is provided for urging sleeve 25 outwardly so that its sealing portion 27 engages sealing surface 31 of poppet head 30, as illustrated in FIG. 2, and thus provides a seal therebetween for all axial positions of poppet 28 with the adapter 16 and coupler 17 unfastened. Spring 34 engages a shoulder 35 on the body of coupler 17 at one end and an outer edge 36 of an annular transition ring 37 at its opposite end. The inner edge of transition ring 36 engages a cooperating shoulder 38 provided on sleeve 25. In effect transition ring 37 extends the cylindrical bore of sleeve 25 within coupler 17 while shielding a portion of the spring 34 to provide better support therefor and help prevent turbulence in the fluid flow. An O-ring type seal 39 is also provided between coupler 17 and sleeve 25 to assure that fluid leakage does not occur between such members. Thus it is seen, as illustrated clearly in FIG. 2, that with coupler 17 unfastened from its cooperating adapter 16 telescoping sleeve 25 is urged by spring 34 to follow poppet 28 and maintain a fluid seal throughout the entire range of travel of such poppet.

Opening and closing of the poppet valve 28 in coupler 17 and thereby control of fluid flow through the assembled coupling 15 is controlled by crankshaft 42 carried within coupler 17 and rotatably supported in a first bearing 43 at one end and a stuffing box 44 at its opposite end. A stem 45 of the crankshaft 42 is rotatable within a bushing 46 contained within the stuffing box 44. The handle lever 40 is non-rotatably keyed to the outer end of the crankshaft 42 as explained more fully hereinafter.

In order to connect the crankshaft 42 to poppet 28, the connecting link 33 has a bifurcated end for receiving stem 29 of poppet 28 therein. A pin 51 passes through suitably arranged holes in the end of stem 29 and the bifurcated end of link 33. Pin 51 is held in position by a cotter pin or the like. The opposite end of link 33 is provided with a bearing and is suitably fastened to crankshaft 42, such that upon rotation of crankshaft 42 connecting link 33 will provide the desired reciprocating motion of poppet 28.

The actuating handle lever 40 is provided for effecting rotation of crankshaft 42 and in this example, handle lever 40 is actuated manually. Handle lever 40 is non-rotatably attached to crankshaft 42 in any suitable manner, for example, by serrating or in the illustrated embodiment, placing a hexagonal end on the terminal outer end of stem 45 and providing a cooperating hexagonal bore 7 in handle lever 40 and then securing such handle lever 40 in position on the stem 45 by a set screw 52 or the like extending through a bifurcated end section of the handle lever 40, as illustrated in FIG. 2.

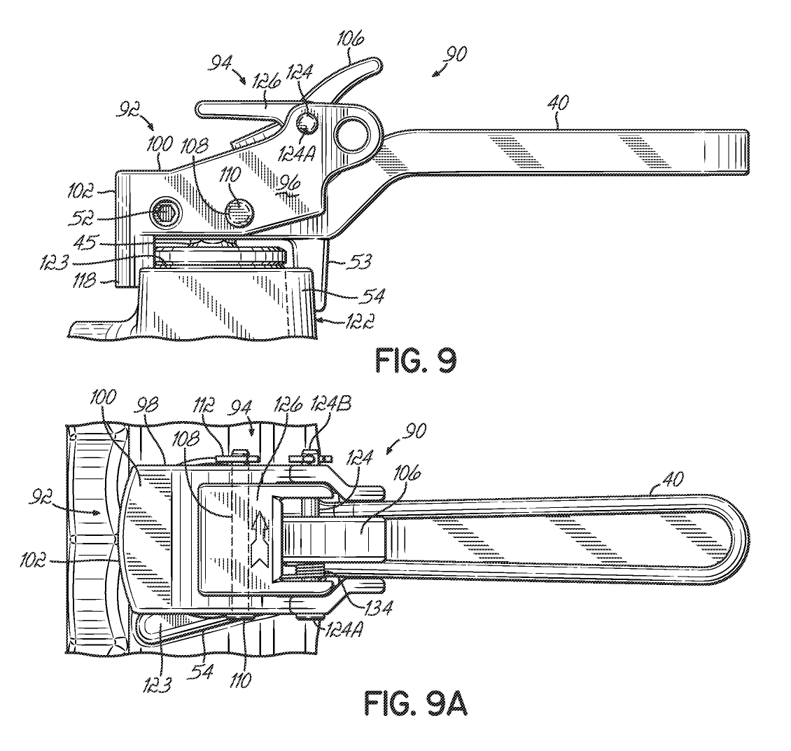

Handle lever 40 has a projection 53 adjacent its hexagonal end bore 7 projecting toward coupler 17. Upon rotating handle lever 40, projection 53 engages a stop 54 (see FIGS. 1, 9 and 9A) having a pair of spaced apart stop surfaces 54A and 54B corresponding respectively to the closed and open positions of the handle lever 40 shown in FIGS. 2 and 3, respectively. The handle lever 40 in FIG. 3 is shown rotated to the position considered the open position when adapter 16 and coupler 17 are fastened together. To move handle lever 40 to its closed position it is rotated clockwise until projection 53 strikes surface 54A. This rotating movement of handle lever 40 is closely correlated with the desired movement of poppet 28 and the telescoping movement of cylindrical sleeve 25.

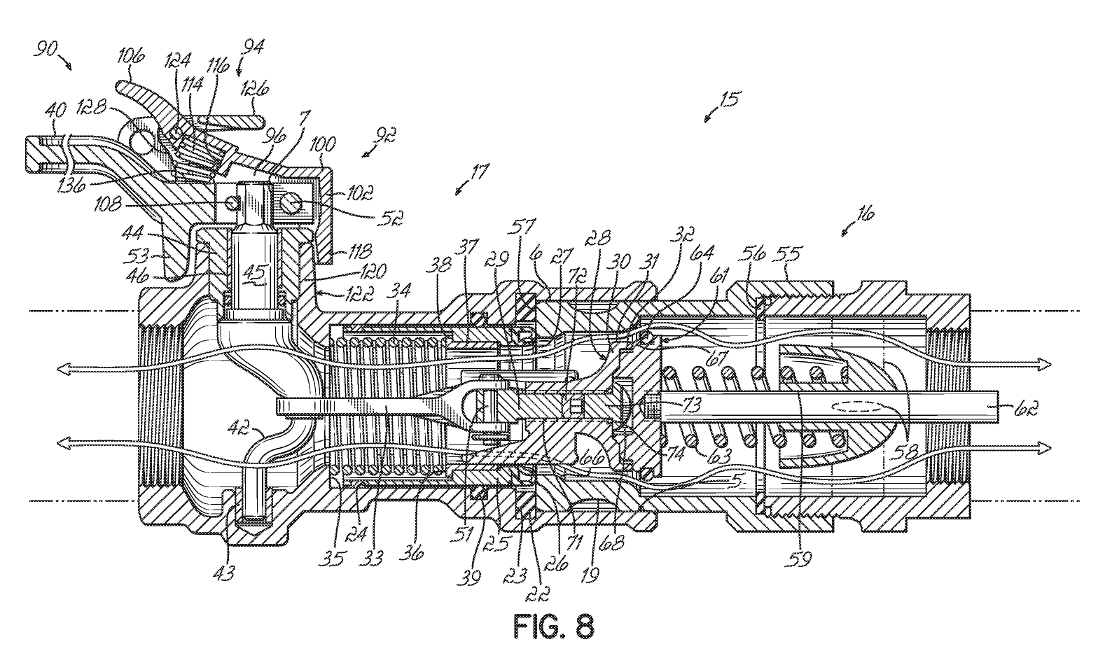

It will be apparent from FIG. 8 that if inadvertently the actuating handle lever 40 were to be actuated to the open position with coupler 17 uncoupled, sleeve 25 would merely follow the poppet 28 and maintain a fluid seal throughout the entire range of movement of poppet 28.

It will be seen also in FIG. 8 that with handle lever 40 moved to the open position that poppet 28 and sleeve 25 are extended outwardly past their normal position of FIG. 2 and thus it would be impossible to couple the members together until such time as actuating handle lever 40 is moved to the closed position. Thus two features are readily illustrated, namely that inadvertent actuation of handle lever 40 with the coupler 17 uncoupled does not result in loss of fluid from coupler 17 and that it is physically impossible to fasten adapter 16 and coupler 17 together until the handle lever 40 is moved to its closed position, illustrated in FIGS. 1 and 2.

As shown in FIG. 4, adapter 16 has a cylindrical sleeve 55 threaded thereon defining that portion of adapter 16 which is received within coupler 17. A seal 56 is provided at the threaded connection to prevent leakage of fluid out of the adapter 16. Sleeve 55 has a shoulder or terminal outer sealing edge 57 which engages seal 22 carried in coupler 17. It will be seen from FIG. 8 that once coupler 17 and adapter 16 are fastened together, and the handle lever 40 is opened to the valve open position, the terminal sealing surface 26 provided on cylindrical sleeve 25 engages shoulder 57 of adapter 16 and provides a fluid tight seal.

Adapter 16 has a bridge or spider therein indicated by the numeral 58 and such spider 58 has a bore 59 therein arranged coaxially with the axis of adapter 16. As best illustrated in FIG. 4, a second poppet or so-called adapter poppet 61 having a stem 62 is provided for movement within adapter 16. Stem 62 is axially slidable back and forth in bore 59 and poppet 61 is spring urged outwardly to a normally closed position by a spring 63 cooperating between spider 58 and the disk-like head 67 of poppet 61.

An annular O-ring 64 is fixed within a groove of poppet 61. With the coupler assembly 15 uncoupled, spring 63 urges poppet 61 and O-ring 64 into sealing engagement with a chamfer 66 provided in the terminal inner end portion 6 of the sleeve portion 55 of adapter 16.

Poppet 61 has a portion spaced inwardly from chamfer 66. As shown in FIG. 5, this portion of poppet 61 is engaged by the terminal outer edge 32 of poppet head 30 such that upon first coupling adapter 16 and coupler 17 as shown in FIG. 5 and then actuating handle lever 40 to its open position shown in FIG. 8, terminal end 32 engages poppet 61 at 67 to unseat the normally closed adapter poppet 61.

As seen in FIG. 8, the opening sequence of coupling 15 is such that upon actuating handle lever 40 to the open position the terminal end 32 of poppet head 30 engages poppet 61, immediately prior to unseating O-ring 64 from chamfer 66 and sealing surface 31 of poppet 28 from its associated sealing portion 27 of cylindrical sleeve 25. This sequence although practically instantaneous assures that only a minute or small amount of fluid is trapped between poppet 61 and head 30 of poppet 28 in the space illustrated at 68 to assure that upon subsequently actuating the actuating means to the closed position and unfastening coupling device 15 a near dry break is provided.

Adjustment is provided for adjusting the relative position of the poppet 28 with respect to coupler 17. This adjusting assures that coupling 15 can be assembled while utilizing components having practical manufacturing tolerances consistent with economy as well as inherently providing for adjustment in the event of wear of components causing poor sealing between the poppet head 30 and sealing portion 27.

As will be apparent from FIG. 2, the poppet stem 29 is threaded into poppet head 30 as illustrated at 71. A set screw 72 is provided and is threaded from the outer end of head 30 into engagement with the threaded portion of stem 29. Set screw 72 when threaded into position acts as a lock against further movement or rotation of poppet head 30. A plug 73 is threaded into the terminal outer end of poppet head 30 and such plug has a seal 74 so that fluid cannot leak through the threaded portion. To adjust the effective position of the poppet 28 it is merely necessary to remove plug 73, loosen set screw 72, and then achieve the desired threading in or out of the poppet head 30. The set screw 72 is then threaded into engagement with the stem portion 29 of poppet 28 followed by threading plug 73 and its seal 74 in position. It will be apparent from the linkage provided that poppet 28 can swivel at the yoke portion of connecting link 33 about pin 51 and thereby is in effect self-aligning to provide a proper seal at all times and even with possible uneven wear of the cooperating sealing portions.

Having thus described the operating components of coupling 15, except for the handle lever locking mechanism to be described hereinafter, the operation of the assembled coupling will be readily apparent from viewing the drawings. With handle lever 40 actuated to its normally closed position the adapter 16 and coupler 17 are fastened together by fastening arms 18 generally as previously described. Handle lever 40 is then rotated to allow fluid to flow through coupling 15. As handle lever 40 is rotated to its open position, the terminal outer edge or projection 32 on poppet 28 engages the poppet 61 at 67. Practically simultaneously thereafter the terminal end portion 26 of the lip seal on sleeve 25 engages the terminal end portion of adapter 16 at 57. This sequence assures only a small amount of fluid is trapped between poppets 28 and 61 at 68, as previously mentioned, as well as further assuring that fluid does not leak out of coupling 15 past seal 22. Continuing to move handle lever 40 so that it is in its fully actuated or open position causes poppet 61 to be completely unseated from its chamfer seat 66 while poppet 28 moves completely away from its sealing portion 27. Thus, a complete fluid path is provided through coupling 15 as shown in FIG. 8. Note that in this position poppet 61 is held with its spring 63 in its compressed position and sleeve 25 is held with its spring 34 in its compressed position. If inadvertently, handles 18 were to be moved to unfasten coupling 15, practically instantaneously, poppet 61 would be urged to seal within its adapter 16 while sleeve 25 would be urged to telescope against poppet 28 and provide a fluid seal. Note that under this hypothetical condition actuating handle lever 40 is still in the open position. Thus a disconnection with minimal spillage is provided. As will be apparent from the foregoing description, and during normal operation, the handle lever 40 in effect overrides the poppet valve in both the adapter 16 and coupler 17 to provide flow through coupling 15.

The coupler assembly 15 heretofore described, except for the handle lever and the locking mechanism associated therewith, are well known in the prior art and described in U.S. Pat. No. 3,473,569. This coupler assembly has been described in this application only for purposes of setting forth the environment of the invention of this application.

With reference now to FIGS. 9-12B, there is illustrated the locking mechanism 90 for preventing rotation of the handle lever 40 until after a latch 92 has been moved to an unlocked position relative to the stops 54A and 54B on the stop portion 54 of the body of the coupler 17. Movement of the latch 92 from its locked to its unlocked position is in turn controlled by a lock 94.

The latch 92 comprises a pair of opposed side plates 96, 98, a top plate 100 and an arcuate end plate 102. A thumb control actuating finger 106 extends rearwardly from the top plate 100. The latch 92 is pivotally mounted to the handle lever 40 by a lower pin 108, the head 110 of which is located on the exterior of the side plate 96 and the opposite end of which extends beyond the opposite side plate 98 and is secured therein by a cotter pin or the like 112. A compression spring 114 is mounted within an interior bore 116 of the latch with one end of the spring resting against the bottom of the bore on the underside of the top plate 100 and the opposite end of the spring resting atop the top surface of the handle lever 40. Consequently, the spring biases the latch 92 to a position in which the lower edge portion 118 of the latch 92 is forced toward the side wall 120 of the upstanding generally annular portion 122 of the body of the coupler 17.

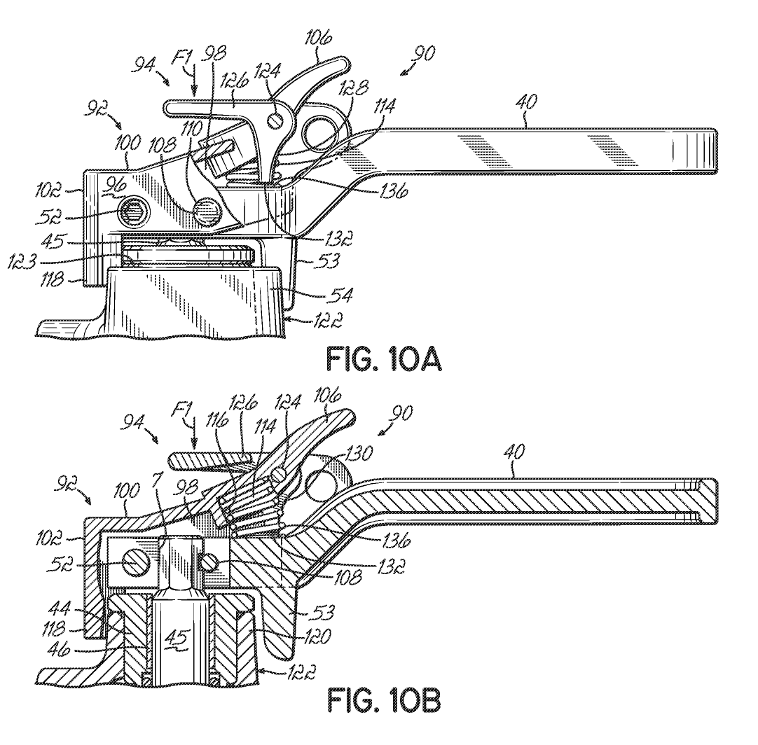

The lock 94 is pivotally mounted upon an upper pin 124. It comprises a generally flat upper plate section 126 from the opposite sides of which a pair of stop fingers 128, 130 extend downwardly (see FIGS. 9 and 10A). The lower end 132 of these fingers are biased by a torsion spring 134 into a position overlying a stop surface 136 on the top of the handle lever 40.

As may be seen most clearly in FIG. 9A, the upper pin 124 has a head end section 124a located on one side of a bifurcated end section of the latch 92 and an opposite end section 124b extending beyond the opposite side of the bifurcated end section of the latch 92. This opposite end is secured by a cotter pin or the like on the outside wall of the bifurcated end section of the latch 92. The torsion spring 134 has one end secured to the finger 106 of the latch 92 and the opposite end secured to the upper plate section 126 of the lock 94 so as to bias the upper plate section 126 of the lock 94 to a raised position (illustrated in FIG. 10A) with the ends 132 of the stop fingers 128, 130 overlying the stop surface 136 of the handle lever 40.

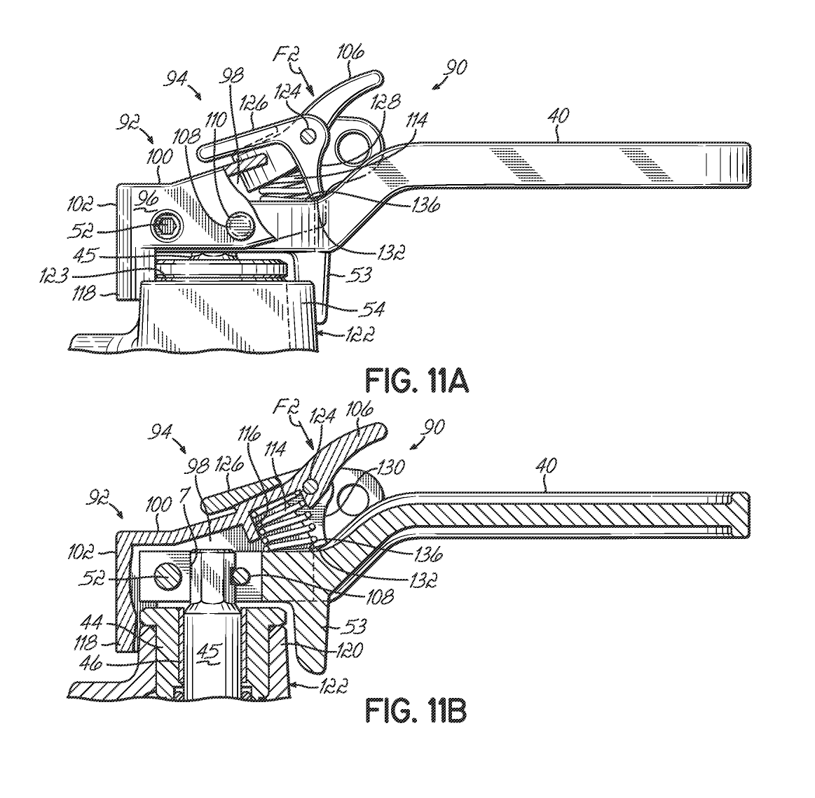

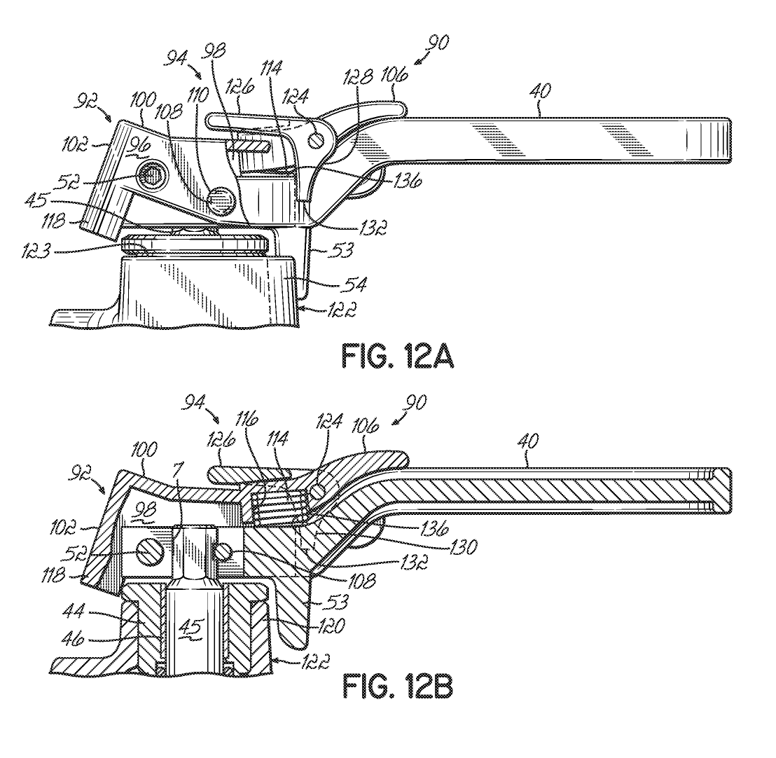

It will be appreciated that with the handle lever 40 in the closed positions of the poppet valves of the coupler end adapter illustrated in FIGS. 1, 9 and 10A, the handle lever 40 is prevented from being rotated about the axis of the stem 45 upon which the handle lever 40 is mounted by engagement of the depending projection 53 of the handle lever 40 with the stop surface 54A and end plate 102 with stop surface 54B. Before the handle lever 40 can be rotated, the latch 92 must be pivoted clockwise, as illustrated in FIGS. 9 and 10A. But the latch 92 is prevented from rotating clockwise about the lower pin 108 by the lock 94 mounted on the upper pin 124 of the latch 92 and the engagement of its lower end 132 with the stop surface 136 on the handle lever 40. Therefore, in order to rotate the handle lever 40 counterclockwise, as viewed in FIGS. 1 and 9A, the upper plate 126 of the lock 94 must first be depressed or pushed downwardly, as indicated by the arrows F1 in FIGS. 10A and 10B. This downward movement from the position illustrated in FIG. 10A to the position illustrated in FIG. 11A, against the force of the torsion spring 134, moves the lower end portion 132 of the stop fingers 128, 130 out of alignment with the stop surface 136 of the handle. With the lock plate 126 depressed, as illustrated in FIG. 11A, the thumb control finger 106 of the latch plate may now be pushed downwardly, as indicated by the arrow F2 in FIGS. 11A and 11B, thereby pivoting the latch 92 about the pin 108 and moving the front end plate 102 out of alignment with the stop surface 54B on the top boss portion 122 of the body of the coupler 17. With the lock 94 and the latch 92 in the positions illustrated in FIGS. 12A and 12B, the handle lever 40 may now be rotated counterclockwise, as viewed in FIGS. 1 and 9, until the projection 53 abuts the stop surface 54B. In the course of moving between the two stop positions of the handle lever 40, the lower edge of the end plate of the latch rides over a top ledge surface 123 (see FIGS, 1, 9 and 9A) of the boss portion 122 of the body of the coupler 17. In this latter or open position of the coupler, i.e., with the projection 53 of the handle engaged with the stop surface 54B of the body of the coupler 17, the poppet valves of the coupler 17 and adapter 16 will both be in the open position, as explained hereinabove.

As seen in FIGS. 11A and 11B, when the handle lever 40 reaches the open position of the valves of the coupler assembly with the projection 53 of the handle engaged with the stop surface 54B, the front or end plate 102 of the latch will then again be biased downwardly by the spring 114 to a position in which the lower end portion of the end plate 102 is engaged with the stop surface 54A. To return the lever handle 40 to the closed position of the poppet valves of the coupler and the adapter, the latch mechanism must again be operated. That is, the upper plate of the lock 94 must be depressed and while held in the depressed position, the thumb control finger of the latch must be depressed so as to again clear the stop surface 54A of the top portion 122 of the body of the coupler. While the top plate of the lock 94 and the thumb control finger of the latch remain depressed, the handle lever 40 may now be rotated clockwise to return the handle to the closed position of the valves until the projection 53 engages the stop surface 54A of the body of the coupler.

While I have described only a single preferred embodiment of the invention of this application, persons skilled in the art will appreciate changes and modifications which may be made without departing from the spirit of my invention. Therefore, I do not intend to be limited except by the scope of the following claims.

I claim:

1. A coupler assembly comprising:
a coupler including a body portion, a poppet valve, and handle lever, wherein the poppet valve is operatively coupled to the handle lever such that rotation of the handle results in movement of the poppet valve, the coupler body portion further including a pair of stop surfaces thereon engageable with a projection of said handle lever for controlling the limits of rotation of the handle lever; and
an adapter attachable to the coupler, the adapter including an adapter valve contained therein, a spring operatively coupled to the adapter valve for biasing the adapter valve to a closed position; and
a lock mechanism including a latch mounted upon said handle lever, said latch being biased into a locking position of said latch wherein said latch, when in said locking position, prevents movement of said handle lever relative to said body portion, said latch when moved to the unlatched position enabling said handle lever to be moved from a position in which said projection is in engagement with said first stop surface of said body portion of said coupler to a second position in which said projection is in engagement with said second stop surface of said body portion of said coupler.

2. The coupler assembly of claim 1 wherein the coupler and the adapter include handle operated cam and slot structure for fixedly attaching the coupler to the adapter.

3. The coupler assembly of claim 1 wherein a lock is mounted upon said latch for preventing unlocking movement of said latch until said lock is first moved to an unlocked position relative to said latch.

4. The coupler assembly of claim 1 wherein the latch is pivotally mounted upon the handle lever and wherein the bias of said latch is provided by a spring operable between said latch and said handle.

5. The coupler assembly of claim 3 wherein the lock is pivotally mounted upon the latch.

6. The coupler assembly of claim 3 wherein the lock is mounted and supported upon the latch by a pivot pin, a torsion spring being mounted upon the pivot pin and operable to bias said lock to a locked position relative to said latch such that said lock must first be depressed against the bias of said torsion spring before said latch can be moved to an unlocked position relative to body portion of said coupler.

7. A coupler adapted for use in combination with an adapter to create a coupler assembly:
said coupler including a body portion, a poppet valve and handle lever wherein the poppet valve is operatively coupled to the handle lever such that rotation of the handle results in movement of the poppet valve, the coupler body portion further including a pair of stop surfaces thereon engageable with a projection of said handle lever for controlling the limits of rotation of the handle lever; and
a lock mechanism including a latch mounted upon said handle lever, said latch being biased into a locking position of said latch wherein said latch, when in said locking position, prevents movement of said handle lever relative to said body portion, said latch when moved to the unlatched position enabling said handle lever to be moved from a position in which said handle lever projection is in engagement with said first stop surface of said body portion of said coupler to a second position in which said projection is in engagement with said second stop surface of said body portion of said coupler.

8. The coupler assembly of claim 7 wherein a lock is mounted upon said latch for preventing unlocking movement of said latch until said lock is first moved to an unlocked position relative to said latch.

9. The coupler assembly of claim 7 wherein the latch is pivotally mounted upon the handle lever and wherein the bias of said latch is provided by a spring operable between said latch and said handle.

10. The coupler assembly of claim 8 wherein the lock is pivotally mounted upon the latch.

11. The coupler assembly of claim 8 wherein the lock is mounted and supported upon the latch by a pivot pin, a torsion spring being mounted upon the pivot pin and operable to bias said lock to a locked position relative to said latch such that said lock must first be depressed against the bias of said torsion spring before said latch can be moved to an unlocked position relative to body portion of said coupler.

12. A dry disconnect coupler assembly comprising:
a coupler including a body portion, a poppet valve contained within the body portion, and a rotatable handle lever mounted upon the body portion;
an adapter attachable to the coupler, the adapter including an adapter valve contained therein and a spring operatively coupled to the adapter valve for biasing the adapter valve to a closed position operatively coupled to the handle lever of said coupler such that rotation of the handle results in movement of the poppet valve and the adapter valve of the adapter;
the coupler body portion further including a pair of stop surfaces thereon engageable with a projection of said handle lever for controlling the limits of rotation of the handle lever; and
a lock mechanism including a latch mounted upon said handle lever, said latch being biased into a locking position of said latch wherein said latch, when in said locking position, prevents movement of said handle lever relative to said body portion, said latch when moved to the unlatched position enabling said handle lever to be moved from a position in which said projection is in engagement with said first stop surface of said body portion of said coupler to a second position in which said projection is in engagement with said second stop surface of said body portion of said coupler.

13. The dry disconnect coupler assembly of claim 12 wherein the coupler and the adapter include handle operated cam and slot structure for fixedly attaching the coupler to the adapter.

14. The dry disconnect coupler assembly of claim 12 wherein a lock is mounted upon said latch for preventing unlocking movement of said latch until said lock is first moved to an unlocked position relative to said latch.

15. The dry disconnect coupler assembly of claim 12 wherein the latch is pivotally mounted upon the handle lever and wherein the bias of said latch is provided by a spring operable between said latch and said handle.

16. The dry disconnect coupler assembly of claim 14 wherein the lock is pivotally mounted upon the latch.

17. The dry disconnect coupler assembly of claim 14 wherein the lock is mounted and supported upon the latch by a pivot pin, a torsion spring being mounted upon the pivot pin and operable to bias said lock to a locked position relative to said latch such that said lock must first be depressed against the bias of said torsion spring before said latch can be moved to an unlocked position relative to body portion of said coupler.
